(19) United States
(12) Patent Application Publication
(10) Pub. No.: US 2016/0162218 A1
(43) Pub. Date: Jun. 9, 2016

(54) DISTRIBUTED DATA DEDUPLICATION IN ENTERPRISE NETWORKS

(71) Applicant: International Business Machines Corporation, Armonk, NY (US)

(72) Inventors: Robert D. Callaway, Holly Springs, NC (US); Ioannis Papapanagiotou, Raleigh, NC (US); Adolfo F. Rodriguez, Raleigh, NC (US)

(21) Appl. No.: 14/559,495

(22) Filed: Dec. 3, 2014

(51) Int. Cl. G06F 3/06; G06F 17/30

(52) U.S. Cl. CPC G06F 3/0641; G06F 17/30371; G06F 3/0619; G06F 3/067

(57) ABSTRACT

Distributed data deduplication may include or utilize containers attached to nodes or byte caches in a cluster or enterprise networks. The containers may store a mapping of byte caches and hashes the byte caches hold. An encoding byte cache may communicate with its attached container to determine which nodes should send which hash values, and may encode an output stream accordingly. Decoding byte cache decompresses the output stream by communicating with its attached container for receiving hash values and associated content from one or more byte caches specified in the output stream.

### FIELD

The present application relates generally to computers and computer applications, and more particularly to data caching and distributed data deduplication in enterprise networks.

### BACKGROUND

Data deduplication compresses data so as to reduce duplicate copies of repeated data, for example, to improve storage utilization and network bandwidth in data transfers. Byte caching deduplicates data and is a technique for replacing repetitive streams of raw application data with shorter “tokens” prior to transmission over the network. Currently byte caching systems are deployed as point-to-point systems.

### BRIEF SUMMARY

A method and system of providing distributed data deduplication in enterprise network may be provided. The method, in one aspect, may comprise receiving a byte stream by a controller of a byte cache. The byte cache may be one of a plurality of byte caches in the enterprise network. The method may also comprise encoding the byte stream by the controller by generating one or more hash values associated with one or more regions of the byte stream. The method may also comprise storing the one or more hash values and associated one or more regions in a storage of the byte cache if the one or more hash values and associated one or more regions do not exist in the storage of the byte cache. The method may also comprise querying a container logic associated with the byte cache to determine which of the one or more hash values to send. The method may also comprise responsive to a response from the container indicating that the one or more hash values do not exist in other byte caches in the enterprise network, attaching all of the one or more hash values and the associated one or more regions to an output stream. The method may also comprise responsive to a response from the container including a hash value and byte cache identifier pair indicating that the hash value exists in a byte cache identified by the byte cache identifier, attaching the hash value and byte cache identifier pair received from the container in the output stream along with non-redundant data of the byte stream and said one or more hash values not identified in the response from the container. The method may further comprise creating a transmission control protocol connection to a receiving byte cache in the enterprise network. The method may further comprise transmitting the output stream to the receiving byte cache.

A system of providing distributed data deduplication in enterprise network, in one aspect, may comprise a byte cache comprising a controller logic and memory. The byte cache being one of a plurality of byte caches in the enterprise network. The controller logic of the byte cache may be operable to receive a byte stream and encode the byte stream by generating one or more hash values associated with one or more regions of the byte stream. The controller logic of the byte cache may be further operable to store the one or more hash values and associated one or more regions in the memory if the one or more hash values and associated one or more regions do not exist in the memory. A container may be connected to the byte cache, the container comprising container logic and container memory, the container memory operable to store a map containing hash value to byte cache identifier mappings indicating which byte caches of the enterprise network store which hash values and associated content. The container may be also operable to receive a query from the byte cache controller requesting which of the one or more hash values to send, the container further operable to send to the byte cache a reply to the query based on the map. Responsive to a response from the container indicating that the one or more hash values do not exist in other byte caches in the enterprise network, the controller logic of the byte cache may be further operable to attach all of the one or more hash values and the associated one or more regions to an output stream. Responsive to a response from the container including a hash value and byte cache identifier pair indicating that the hash value exists in a byte cache identified by the byte cache identifier, the controller logic of the byte cache may be further operable to attach the hash value and byte cache identifier pair received from the container in the output stream along with non-redundant data of the byte stream and one or more hash values not identified in the response from the container. The output stream may be transmitted via a transmission control protocol connection to a receiving byte cache in the enterprise network.

A computer readable storage medium storing a program of instructions executable by a machine to perform one or more methods described herein also may be provided.

Further features as well as the structure and operation of various embodiments are described in detail below with reference to the accompanying drawings. In the drawings, like reference numbers indicate identical or functionally similar elements.

### BRIEF DESCRIPTION OF THE SEVERAL VIEWS OF THE DRAWINGS

FIG. 1 is a diagram illustrating distributed network compression architecture in one embodiment of the present disclosure.

FIG. 2 is a state diagram illustrating a distributed encoding byte cache operation in one embodiment of the present disclosure.

FIG. 3 is a diagram illustrating a distributed decoding byte cache operation in one embodiment of the present disclosure.

FIG. 4 illustrates a schematic of an example computer or processing system that may implement a distributed data deduplication system in one embodiment of the present disclosure.

### DETAILED DESCRIPTION

Byte caching systems are also referred to as redundancy elimination, WAN Optimization controllers, and may identify redundant content at the byte level. A byte caching system may include an encoder that identifies the regions of repeated content in the stream, represents the repeated content with a hash value, and sends a token to the decoder. An encoder may use a sliding window fingerprinting technique to produce fingerprints that can identify redundant content. The fingerprints are hash values of a constant window size. A decoder receives the token and the hashes and reconstructs the data. In point-to-point systems, both the encoder and the decoder are synchronized in terms of the hashes and the content in order to perform the network compression.

In one embodiment of the present disclosure, a distributed byte cache is presented, which deduplicates data, for example, in a stream-based distributed network. Techniques for distributed byte cache in one embodiment utilize a set of containers. In one aspect, the set of containers may be attached or connected to the byte caches. In another aspect, the set of containers may be independent in-memory distributed nodes. The containers contain a map of the location of the hashes and the caching nodes (byte caches) that have them. When an encoding byte cache receives data to encode, it creates the fingerprints, calculates the hashes to be used for deduplication, and queries the closest container. If another byte cache is identified to contain the same hashes” (or tokens), and they can be delivered faster, the container responds with the tokens of the content that the encoding byte cache does not have to send. In one aspect, the containers may continuously update the mapping information related to the location of the hashes and the caching nodes that have them, for example, utilizing peer-to-peer communication among the containers. The encoder then sends the non-redundant content, the tokens from the container, and the local tokens to the decoder. On the receipt of the tokens and the content, the decoding byte cache notifies the closest container. The closest container then broadcasts the updated map to the other containers. This assures that an overlay routing information is known across the system.

The techniques of the present disclosure in one embodiment may enable network data deduplication in distributed environments, for example, mobile, cloud or sensor networks. In one embodiment the nodes cooperate to perform deduplication, for example, resulting in decrease in the network delay since a closer byte caching node can deliver the hashes and/or content faster than the encoder. The techniques further may allow for resiliency, scalability and modularity since the system can function after either a node failure, or when a node is added.

In one embodiment, a distributed data deduplication system of the present disclosure functions at the byte level, and includes in-memory byte cache containers which contain the mapping of the system. An encoding operation is provided in which the encoding byte cache queries the closest container, and the container notifies another node to send the hashes and/or content. Further, a container messaging technique that defines how the containers communicate may be provided. The distributed data deduplication system of the present disclosure may also include a clustering container topology that enables system scalability.

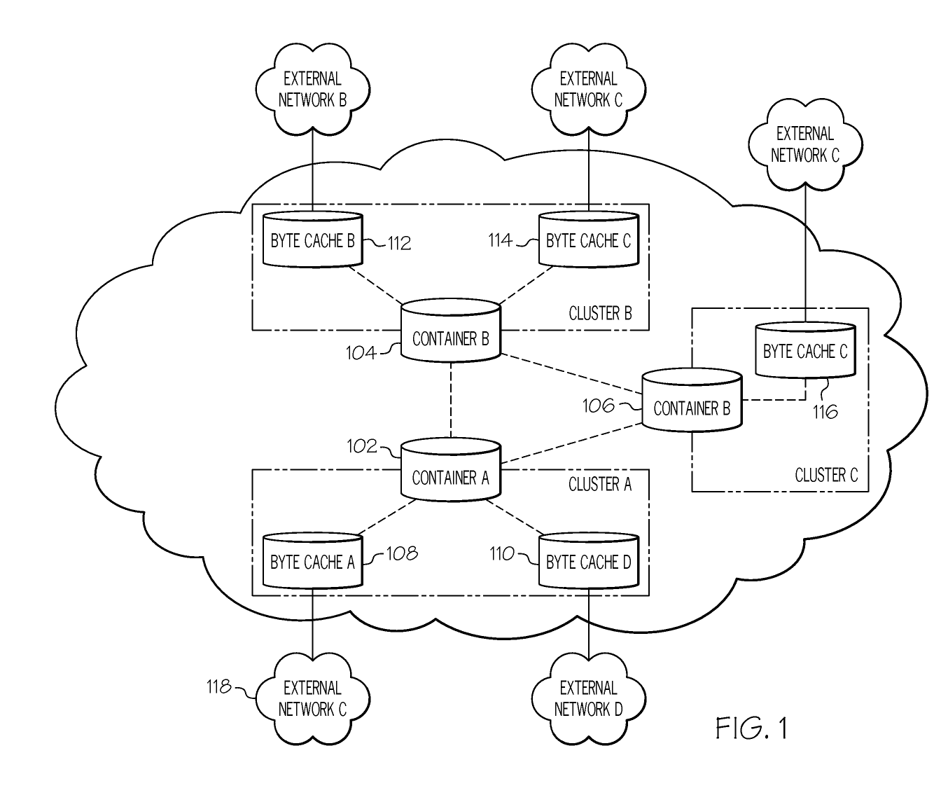

FIG. 1 is a diagram illustrating distributed network compression architecture in one embodiment of the present disclosure. The distributed network of byte caches in one embodiment of the present disclosure includes containers 102, 104, 106 that may be considered as a backbone of the distributed byte caches 108, 110, 112, 114, 116. The containers can be part of the byte caching system, for example, pre-allocated non-volatile space, or they can be in-memory caches distributed in the network. In one embodiment, the containers are an overlay mapping of hashes and identifiers (IDs) of the byte caches that have the content. In one aspect, the containers may be an overlay mapping of those considered as the “most important” hashes and the IDs. In one embodiment, access to the containers is an O(1) operation. In one embodiment, byte caches 108, 110, 112, 114, 116 consult the containers 102, 104, 106 for the best way to perform deduplication. Each container can serve one or more byte caches and the serving byte caches form clusters. For example, container at 102 may server byte caches at 108 and 110; container at 104 may serve byte caches at 112 and 114; container at 106 may serve byte cache at 116. In one embodiment, the number of containers may be at most equal to the number of the byte caches. In one embodiment a container may serve a cluster of one or more byte caches.

Each byte cache may include logic and memory and/or storage, and stores a dictionary of hashes and corresponding content in a database, e.g., in its local storage. Byte cache logic, for example, may be part of a wide area network (WAN) optimization controller and the memory and/or storage of the byte cache may be part of the WAN optimization storage device. Byte cache logic is also referred to as byte cache controller in the present disclosure. Byte cache logic or controller runs on one or more hardware processors. As data is received, e.g., from an external network (e.g., 118), a byte cache (e.g., 108) may build a local dictionary by assigning a hash value or token to represent regions or portions of the received data. The local dictionary is stored in the byte cache's local storage. The logic of a byte cache may include processing logic for encoding and decoding data, also referred to as an encoder of a byte cache and a decoder of a byte cache. Each container (e.g., 102) may also contain processing logic and memory or storage, and store a map of hash values and byte cache identifiers that store the associated content (e.g., the dictionary of hashes and corresponding content).

In one embodiment, all containers (e.g., 102, 104, 106) contain the same mapping. For example, once a decoding byte cache send an insert and/or update message to the closest container, the container then broadcasts the information to the rest of the containers, along with the request of the byte caches that have missed.

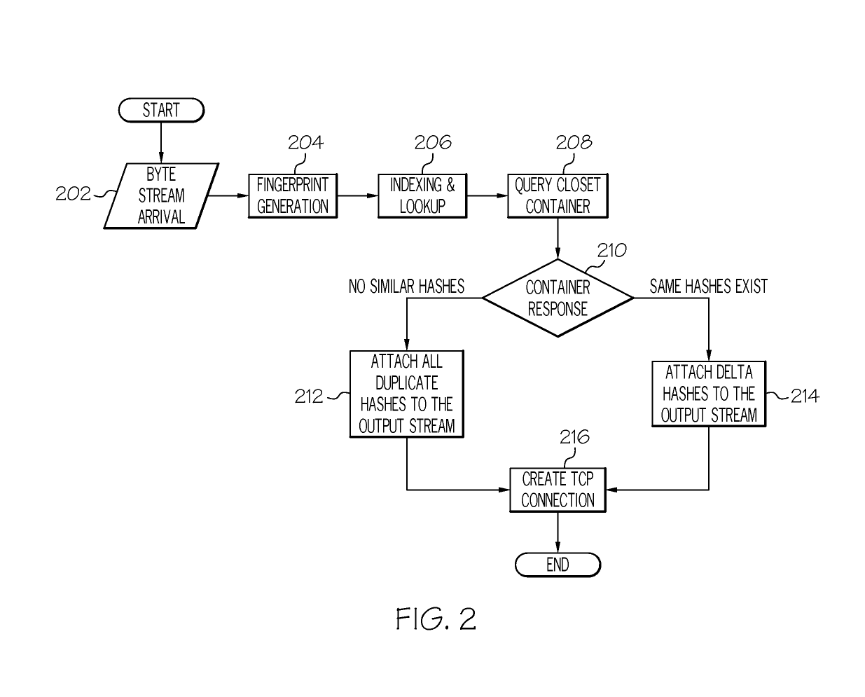

FIG. 2 is a state diagram illustrating a distributed encoding byte cache operation in one embodiment of the present disclosure. At 202, byte stream may arrive from an external network to a network of computer systems, e.g., a cloud, which implements a distributed byte caching system of the present disclosure. At 204, responsive to receiving the byte stream, an encoder of a byte cache associated with a device that received the byte stream (e.g., an attached encoding byte cache) may perform fingerprinting, e.g., using the Rabin fingerprint technique. Fingerprinting identifies or generates a hash value for data. One or more hash values corresponding to one or more regions or segments of byte stream may be generated.

At 206, the encoder of the byte cache may also perform indexing and lookup. Indexing and lookup process generally includes querying to determine whether the generated fingerprint already exists or stored in the byte cache. If not, then the fingerprint and the content the fingerprint is representing are stored.

At 208, the encoder of the byte cache may then query the closest container. For instance, the query contains the hashes that the encoding byte cache has generated. The hashes are usually subset of the fingerprints. A query can be a structured message such as a JavaScript Object Notation (JSON) or Extensible Markup Language (XML) file. The closest container may be one that is attached to the byte cache, or stored in a node that is closest distance from the byte cache. As shown at 210, the query's response may either be a null message, or a structured message with the hashes, and the ID of the byte caches that have been selected by the container. The null message indicates that there is no other byte cache that contains similar hashes; hence the encoder can proceed with attaching all fingerprints to the output stream as shown at 212.

In the case that a map of {hash, byte cache ID} is returned from the container, at 214 the byte cache attaches delta hashes to the output stream. Delta hashes refer to hashes that are found in the closest container or locally produced hashes. For instance, the encoding byte caches may perform a delta operation to determine which hashes are not found in the closest container. The encoded data may include (i) the non-redundant content, (ii) a hash and ID of the byte cache that was included in the container's response and (iii) the locally produced hashes, i.e., the ones that were not included in the container's response. For example, the non-redundant content is sent as is. The locally produced hashes are the hashes that were not found to be located in other containers/byte caches after the request from the encoding byte cache to the closest container, or the ones that the closest container identified it would take more time to send them from other byte caches than from the encoding byte cache, for example, based on round-trip-time (RTT) calculation.

At 216, transmission control protocol (TCP) connection is created and the output stream is sent via the connection to a receiving byte cache. While the same hash may be located in the multiple byte caches, in one embodiment the container sends only one map for each hash {hash, byte cache ID} to the encoder. This selection may be performed by the container through the use of weight system or weighing algorithm. The present disclosure does not limit the type of weights, for example, it can be anything from lowest RTT, lowest bandwidth utilization, speed such as faster hash generation, or any combination thereof.

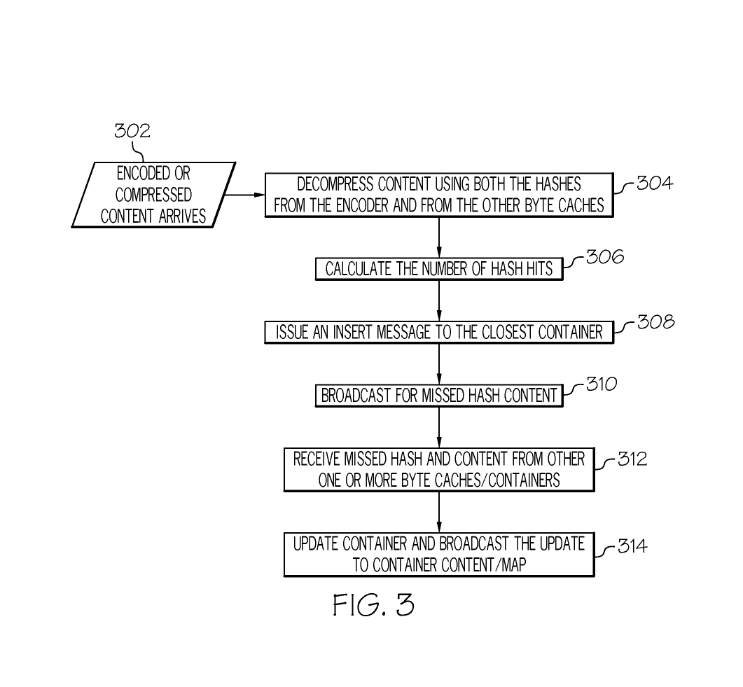

FIG. 3 is a diagram illustrating a distributed decoding byte cache operation in one embodiment of the present disclosure. In one embodiment decoding operation may be performed as follows. At 302, the compressed content arrives. At 304, responsive to receiving the content, a decoding byte cache (or a decoder or decoding logic of a byte cache) decompresses the content using both the hashes from the encoder and from the other byte caches. For example, the decoding byte cache uses the hashes in the content and any non-redundant or non-deduplicated data in the content to reconstruct the content. Hashes contained in the content but are not found in the decoding byte cache (or its attached container) are considered misses. Hashes contained in the content and found in the decoding byte cache (or its attached container) are considered hits.

At 306, the decoding byte cache calculates the number of hash hits. As described above, if a hash encoded in the received content exists in the decoding byte cache, then it is considered a hash hit. The decoding byte cache identifies the hashes that hit or miss. The hashes in the received content that do not hit are still pending to be reconstructed. A miss implies that a decoding byte cache did not receive all the hashes from the encoding byte cache. Hence, the decoding byte may perform an extra operation that of communicating with the closest container. The closest container then may broadcast a message to the rest of the containers to get the hashes/content to the decoding byte cache.

Thus, for example, through an insert message, the decoding byte cache may notify the closest container (e.g., the container to which the decoding byte cache is attached) of the hashes that hit and the hashes that miss (hence are missing). The closest container then requests the rest of the containers to notify their byte caches to send the missing hashes. For example, as shown at 308, the decoding byte cache issues an insert message to the closest container or one that it is associated with. In one embodiment, the insert message includes the hashes that did not hit, and updates to the hit counter of the container for the hashes that did hit. Responsive to receiving the message that includes the hashes that missed, the container (attached to the decoding byte cache) at 310 broadcasts to the other one or more containers, e.g., which are connected to one or more byte caches that have the new hash and content (the missed hash at the closest container). The container also may use the hash hit information contained in the message to update a timer associated with the hashes in the container. The number of hash hits and time information associated with hashes may be used in replacement strategies.

At 312, the decoding byte cache receives the missed hash and associated content from another byte cache identified by the byte cache ID encoded in the content. The decoding byte cache may send a message to the attached container (e.g., the container that is closest to the decoding byte cache) that the decoding byte cache received the missed hash and associated content. Thus, the decoding byte cache can complete reconstructing the content.

In one aspect, upon receipt of the insert message from the decoding byte cache, the container starts a timer for all the outstanding hashes. After the expiration of a pre-defined period of time and if the outstanding hashes have not been received by the decoding byte cache, the closest container to the decoding byte cache sends a unicast request message to the closest container to the encoding byte cache. The unicast request message can be in form of a JSON/XML file, and contains the missing hashes. The unicast request message is then forwarded to the encoding byte cache. The encoding byte cache contains the logic to process the request message and sends the missing hashes.

At 314, the attached container updates the mapping to indicate that the decoding byte cache has the missed cache. The attached container broadcasts a message that a container update has occurred. For example, the container is updated specifying which byte caches are storing which hashes. The mapping information is updated in all the containers connected in the network.

The following container replacement strategy may be utilized in one embodiment of the present disclosure. Hash replacement in the container may take place, for example, in cases when an encoding byte cache is full or a container is full. In the case that an encoding byte cache is full, the byte cache queries the closest container in order to know which hashes have to be sent (delta hashes) and which do not. These delta hashes and their content (content represented by hash) are only stored in the encoding byte cache. As described above, delta hashes refer to hashes that were found in the closest container or else the locally produced hashes. An encoding byte cache performs a delta operation to determine which hashes were not found in the closest container. The byte cache then updates the closest container on which one or more hashes have been removed. For example, a modified First-In-First-Out (FIFO) methodology may be used to determine which hashes to evict. In the modified FIFO methodology, the oldest is evicted. In one embodiment, the hashes in the container contain a timer. That timer is updated anytime there is a hit in the decoding byte cache. Decoding byte cache sends this hit information to its closest container in its insert/update message sent to the closes container. A similar operation takes place at the decoding byte cache. In the case that a container is full, the container watches the temporal change of the hit counter of each hash. The oldest hash is evicted at the time of any insertion. This assures that new hashes enter the containers, but also low hit hashes are evicted. For example, hashes of encrypted content chunks do not tend to have many hits.

Container messaging is described as follows. In one embodiment, a container may generate a broadcast message after any insert or eviction of hash in the container. One or more of the following implementations may be provided for the container issuing a broadcast message. For example, a container may issue a broadcast message after any hash update at the container. This implementation may be used when the interarrival of container updates is long. As another example, a container may buffer the updates, and send them at predefined intervals. Yet as another example, a container may buffer the updates, and send them after a buffer is full or another criteria or threshold is met, for example, delta changes are more than byte threshold.

Synchronization is described as follows. If a broadcast message is not received by an adjacent container, the system can still operate. For instance, if a container dies, it will not receive updates. There is also an option to automatically synchronize the containers at predefined time intervals. Every new container may be inserted to the broadcasting domain in order to start receiving the hashes from the other containers.

The following describes example operations of distributed data deduplication in enterprise networks of the present disclosure in one embodiment. In the example scenarios, each node (byte cache) has a container and weight. For example, each node is connected to one container, e.g., Node A is connected to Container A (Node A's closest container). As an example, the weight value is based on the lowest RTT. A node is a byte cache system and a container is used as a middleware system to establish an overlay routing protocol.

In the example scenario Node A and attached Container A, Node B and attached Container B, Node C and attached Container C, and Node D and attached Container D initially are empty. Consider for example that Node A wants to send to Node D the content which is represented by the hashes 1, 2, 3, 4. Node A and Node D are initially empty. Node A queries its container, Container A. Container A returns null message since there are no byte caches that have the hashes 1, 2, 3, 4. Therefore, Node A sends all of the content including the fingerprints (hashes 1, 2, 3, 4) to Node D. Node A and Node D have 1,2,3,4 in their memory (e.g., hashes 1,2,3,4 and corresponding content). The receiving node's container, in this example, Container D broadcasts that Nodes A and D have the hashes 1,2,3,4. RTT of broadcast is recorded. Redundancy=0%. The following describes the container state (content of container):
A→1,2,3,4
B→-
C→-
D→1,2,3,4

Continuing with the above example, consider that Node B wants to send to Node C the content which is represented by the hashes 1, 5, 6, 7. Node B and C are currently empty. Node B queries a container closest to Node B or associated with it, e.g., Container B. Container B knows through the prior broadcasting of Container A's status that Node A and Node D have hash 1 and associated content, and that no other nodes have hashes 5, 6, 7. Container B may perform the operation min{RTT{(B→C), (A→C), (D→C)}. Assume that min{RTT(B→C), RTT(A→C), RTT(D→C)}=RTT(B→C). Thus, Container B responds to Node B that hashes 1, 5, 6, 7 and associated content represented by those hashes are to be sent from Node B, e.g., sending a null message. Content is sent. Node B and C have 1, 5, 6, 7 (the hashes and corresponding content represented by the hashes). The receiving node's container, in this example, Container C broadcasts that Nodes B and C have the hashes 1, 5, 6, 7 and associated content. RTT of broadcast is recorded. Redundancy=0% or 25%. The following describes the container state:
A→1,2,3,4
B→1,5,6,7
C→1,5,6,7
D→1,2,3,4

Further continuing with the example, Node A wants to send to Node C the content which is represented by the hashes 1, 2, 4, 5. Node A queries its closest container, Container A. Container A's reply informs Node A that Node C has content represented by hash 1, hence does not need to send content related to hash 1 to Node C. Container A knows that Node C has content represented by hash 1 from the previous broadcast from a container of Node C. Container A knows that Node D also has hashes 2, 4 (e.g., from the mapping of hashes and byte cache IDs). Hence Container A selects min{RTT(A→C), RTT(D→C)} for those hashes. Based on Container A's computation based on weight, Container A replies to Node A's query with the determined {hash, byte cache ID} pairs, if those hashes are to be sent from byte cache other than Node A. Thus, content represented by hashes 2 and 4 are sent by best choice from this minimization computation. Decoding byte cache (Node C) requests and receives those hashes from the determined byte caches. Container C broadcasts that Nodes A and C have 1, 2, 4, 5. RTT of broadcast is recorded. Redundancy=25% or 75%. Briefly, redundancy may be computed as follows: Node A calculated 4 hashes (1, 2, 4, 5) that represent the content. Node C already has hash 1. This is 25% redundancy. Node D has hashes 2, 4, hence if it min{RTT(A→C),RTT(D→C)}=RTT(D→C) it will be +50% redundancy. Therefore, total redundancy is 75%, but if RTT(A→C) is selected then the redundancy is 25%. The following describes the container state:
A→1,2,3,4,5
B→1,5,6,7
C→1,2,4,5,6,7
D→1,2,3,4

Continuing further with the example, Node B wants to send to Node D the content which is represented by the hashes 8, 9, 10, 11. Node B and Node D do not have the content. Node B queries Container B. Container B responds with a null message because Container B knows that neither Node A nor Node C has the content. The content represented by the hashes 8, 9, 10, 11 is sent from Node B to Node D. Node B and Node D now have hashes 8, 9, 10, 11 and represented content. Container D broadcasts that it has hashes 8, 9, 10, 11. RTT of broadcast is recorded. Redundancy=0%. The following describes the container state:
A→1,2,3,4,5
B→1,5,6,7,8,9,10,11
C→1,2,4,5,6,7
D→1,2,3,4,8,9,10,11

Further continuing with the example, Node C wants to send to Node D the content which is represented by the hashes 1, 2, 5, 8, 9. Node C queries Container C. Container C knows that Node D has hashes 1, 2, 8, 9, from the mapping of hashes and byte cache IDs. Container C knows that Node A and Node B have 5 (as well as Node C), hence selects min{RTT(C→D), RTT(A→D), RTT(B→D)}. Content for 5 is sent by the best choice. For example, Container C sends a reply to Node C which hashes should be sent from which byte caches. Node D receives and decodes the content from Node C, and receives hashes and associated content from those specified in the content. Container D broadcasts that Nodes C and D have 1, 2, 5, 8, 9. RTT of broadcast is recorded. Redundancy=80% or 100%. The following describes the container state:
A→1,2,3,4,5
B→1,5,6,7,8,9,10,11
C→1,2,4,5,6,7,8,9
D→1,2,3,4,5,8,9,10,11

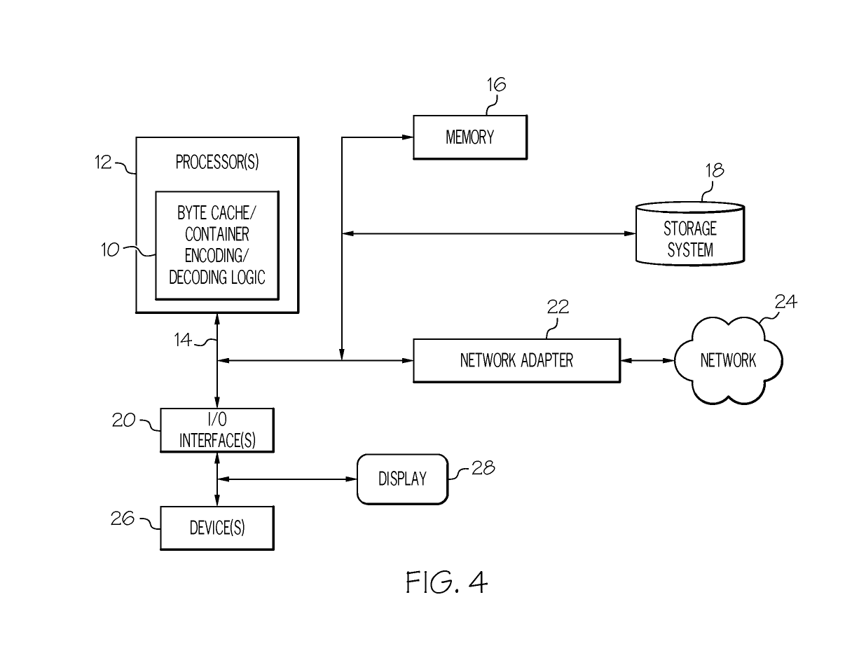

FIG. 4 illustrates a schematic of an example computer or processing system that may implement a distributed data deduplication system in one embodiment of the present disclosure. The computer system is only one example of a suitable processing system and is not intended to suggest any limitation as to the scope of use or functionality of embodiments of the methodology described herein. The processing system shown may be operational with numerous other general purpose or special purpose computing system environments or configurations. Examples of well-known computing systems, environments, and/or configurations that may be suitable for use with the processing system shown in FIG. 4 may include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

The computer system may be described in the general context of computer system executable instructions, such as program modules, being executed by a computer system. Generally, program modules may include routines, programs, objects, components, logic, data structures, and so on that perform particular tasks or implement particular abstract data types. The computer system may be practiced in distributed cloud computing environments where tasks are performed by remote processing devices that are linked through a communications network. In a distributed cloud computing environment, program modules may be located in both local and remote computer system storage media including memory storage devices.

The components of computer system may include, but are not limited to, one or more processors or processing units 12, a system memory 16, and a bus 14 that couples various system components including system memory 16 to processor 12. The processor 12 may include a module 10 that performs the methods described herein. The module 10 may be programmed into the integrated circuits of the processor 12, or loaded from memory 16, storage device 18, or network 24 or combinations thereof.

Bus 14 may represent one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system may include a variety of computer system readable media. Such media may be any available media that is accessible by computer system, and it may include both volatile and non-volatile media, removable and non-removable media.

System memory 16 can include computer system readable media in the form of volatile memory, such as random access memory (RAM) and/or cache memory or others. Computer system may further include other removable/non-removable, volatile/non-volatile computer system storage media. By way of example only, storage system 18 can be provided for reading from and writing to a non-removable, non-volatile magnetic media (e.g., a “hard drive”). Computer system may also communicate with one or more external devices 26 such as a keyboard, a pointing device, a display 28, etc.; one or more devices that enable a user to interact with computer system; and/or any devices (e.g., network card, modem, etc.) that enable computer system to communicate with one or more other computing devices. Such communication can occur via Input/Output (I/O) interfaces 20.

Still yet, computer system can communicate with one or more networks 24 such as a local area network (LAN), a general wide area network (WAN), and/or a public network (e.g., the Internet) via network adapter 22. As depicted, network adapter 22 communicates with the other components of computer system via bus 14. It should be understood that although not shown, other hardware and/or software components could be used in conjunction with computer system. Examples include, but are not limited to: microcode, device drivers, redundant processing units, external disk drive arrays, RAID systems, tape drives, and data archival storage systems, etc.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

We claim:

1. A method of providing distributed data deduplication in enterprise network, comprising:
receiving a byte stream by a controller of a byte cache, the byte cache being one of a plurality of byte caches in the enterprise network;
encoding the byte stream by the controller by generating one or more hash values associated with one or more regions of the byte stream;
storing the one or more hash values and associated one or more regions in a storage of the byte cache if the one or more hash values and associated one or more regions do not exist in the storage of the byte cache;
querying a container logic associated with the byte cache to determine which of the one or more hash values to send;
responsive to a response from the container indicating that the one or more hash values do not exist in other byte caches in the enterprise network, attaching all of the one or more hash values and the associated one or more regions to an output stream;
responsive to a response from the container including a hash value and byte cache identifier pair indicating that the hash value exists in a byte cache identified by the byte cache identifier, attaching the hash value and byte cache identifier pair received from the container in the output stream along with non-redundant data of the byte stream and said one or more hash values not identified in the response from the container;
creating a transmission control protocol connection to a receiving byte cache in the enterprise network; and
transmitting the output stream to the receiving byte cache.

2. The method of claim 1, wherein to respond to the querying from the byte cache, the container logic searches a map containing hash value to byte cache identifier mappings indicating which byte caches of the enterprise network store which hash values and associated content.

3. The method of claim 2, wherein responsive to finding more than one byte cache storing one or more of the hash values, utilizing a weighing algorithm to select a hash value to byte cache identifier pair to send to the byte cache.

4. The method of claim 1, further comprising:
decoding the output stream received at the receiving byte cache by decompressing the output stream into a message using the hash values included in the output stream;
sending the decompressed message to a destination;
updating the map to include the receiving byte cache and the hash values mapping; and
broadcasting that the receiving byte cache stores the hash values included in the output stream.

5. The method of claim 4, wherein the decoding further comprises counting a number of hits for the hash values included in the output stream.

6. The method of claim 5, further comprising updating a timer associated with the hash values in the output stream that hit in the receiving byte cache, the timer used for replacement strategy.

7. The method of claim 4, wherein responsive to receiving the output stream that contains the hash value and byte cache identifier pair, requesting from the byte cache identified by the byte cache identifier, the hash value and associated represented content.

8. A computer readable storage medium storing a program of instructions executable by a machine to perform a method of providing distributed data deduplication in enterprise network, the method comprising:
receiving a byte stream by a controller of a byte cache, the byte cache being one of a plurality of byte caches in the enterprise network;
encoding the byte stream by the controller by generating one or more hash values associated with one or more regions of the byte stream;
storing the one or more hash values and associated one or more regions in a storage of the byte cache if the one or more hash values and associated one or more regions do not exist in the storage of the byte cache;
querying a container logic associated with the byte cache to determine which of the one or more hash values to send;
responsive to a response from the container indicating that the one or more hash values do not exist in other byte caches in the enterprise network, attaching all of the one or more hash values and the associated one or more regions to an output stream;
responsive to a response from the container including a hash value and byte cache identifier pair indicating that the hash value exists in a byte cache identified by the byte cache identifier, attaching the hash value and byte cache identifier pair received from the container in the output stream along with non-redundant data of the byte stream and said one or more hash values not identified in the response from the container;
creating a transmission control protocol connection to a receiving byte cache in the enterprise network; and
transmitting the output stream to the receiving byte cache.

9. The computer readable storage medium of claim 8, wherein to respond to the querying from the byte cache, the container logic searches a map containing hash value to byte cache identifier mappings indicating which byte caches of the enterprise network store which hash values and associated content.

10. The computer readable storage medium of claim 9, wherein responsive to finding more than one byte cache storing one or more of the hash values, utilizing a weighing algorithm to select a hash value to byte cache identifier pair to send to the byte cache.

11. The computer readable storage medium of claim 8, further comprising:
decoding the output stream received at the receiving byte cache by decompressing the output stream into a message using the hash values included in the output stream;
sending the decompressed message to a destination;
updating the map to include the receiving byte cache and the hash values mapping; and
broadcasting that the receiving byte cache stores the hash values included in the output stream.

12. The computer readable storage medium of claim 11, wherein the decoding further comprises counting a number of hits for the hash values included in the output stream.

13. The computer readable storage medium of claim 12, further comprising updating a timer associated with the hash values in the output stream that hit in the receiving byte cache, the timer used for replacement strategy.

14. The computer readable storage medium of claim 11, wherein responsive to receiving the output stream that contains the hash value and byte cache identifier pair, requesting from the byte cache identified by the byte cache identifier, the hash value and associated represented content.

15. A system of providing distributed data deduplication in enterprise network, comprising:
a byte cache comprising a controller logic and memory, the byte cache being one of a plurality of byte caches in the enterprise network,
the controller logic of the byte cache operable to receive a byte stream and encode the byte stream by generating one or more hash values associated with one or more regions of the byte stream,
the controller logic of the byte cache further operable to store the one or more hash values and associated one or more regions in the memory if the one or more hash values and associated one or more regions do not exist in the memory; and
a container connected to the byte cache, the container comprising container logic and container memory, the container memory operable to store a map containing hash value to byte cache identifier mappings indicating which byte caches of the enterprise network store which hash values and associated content,
the container operable to receive a query from the byte cache controller requesting which of the one or more hash values to send, the container further operable to send to the byte cache a reply to the query based on the map,
responsive to a response from the container indicating that the one or more hash values do not exist in other byte caches in the enterprise network, the controller logic of the byte cache further operable to attach all of the one or more hash values and the associated one or more regions to an output stream;
responsive to a response from the container including a hash value and byte cache identifier pair indicating that the hash value exists in another byte cache identified by the byte cache identifier, the controller logic of the byte cache further operable to attach the hash value and byte cache identifier pair received from the container in the output stream along with non-redundant data of the byte stream and said one or more hash values not identified in the response from the container,
wherein the output stream is transmitted via a transmission control protocol connection to a receiving byte cache in the enterprise network.

16. The system of claim 15, wherein responsive to finding more than one byte cache storing one or more of the hash values from the map, the container logic utilizing a weighing algorithm to select a hash value to byte cache identifier pair to send to the byte cache.

17. The system of claim 15, wherein the output stream is decompressed at the receiving byte cache into a message using the hash values included in the output stream, and sent to a destination and wherein the map is updated at the receiving byte cache by a container connected to the receiving byte cache.

18. The system of claim 17, wherein the map is updated for all containers in the enterprise network.

19. The system of claim 17, wherein responsive to receiving the output stream that contains the hash value and byte cache identifier pair, the receiving byte cache requests the hash value and associated content from said another byte cache identified by the byte cache identifier.

20. The system of claim 19, wherein responsive to not receiving the requested hash value and associated content from said another byte cache identified by the byte cache identifier within a defined period of time, a request message is sent to the container connected to the byte cache by the container connected to the receiving byte cache, and the byte cache sends the requested hash value and associated content.
